(19) United States
(12) Patent Application Publication
(10) Pub. No.: US 2008/0036658 A1
(43) Pub. Date: Feb. 14, 2008

(54) Method And An Arrangement For Estimating The Position Of A Mobile Terminal With A Prediction Method, And A Mobile Terminal

(76) Inventors: Markus Mikkolainen, Vantaa (FI); Simo Sarkka, Espoo (FI)

Correspondence Address: JACOBSON HOLMAN PLLC, 400 SEVENTH STREET N.W., SUITE 600, WASHINGTON, DC, 20004, US

(21) Appl. No.: 10/560,277

(22) PCT Filed: Jun. 10, 2004
(86) PCT No.: PCT/FI04/50088

§ 371 Date: May 8, 2006

(30) Foreign Application Priority Data
Jun. 12, 2003 (FI) 20035094

(51) Int. Cl. G01S 3/14

(52) U.S. Cl. 342/451

(57) ABSTRACT

A method an arrangement to reduce amount data to be sent in a tracking system of a mobile station (MTT) having a positioning device to obtain positioning data, and the mobile station (MTT) and the server (S) perform the following steps: the mobile station (MTT) sends its dynamic state parameters including at least the position and velocity, which are derived from the positioning measurements, to server (S), the mobile station (MTT) computes an error criterion based on said sent dynamic state and current dynamic state, which is derived from new positioning measurements, such that the error criterion is calculated based on at least sent and current velocities, the mobile station (MTT) sends a set of new dynamic state parameters, when the said error criterion is over a predefined limit.

A method and an arrangement for estimating the position of a mobile terminal with a prediction method, and a mobile terminal

The application concerns tracking of a mobile station with GPS or equivalent positioning system and minimizing the amount of data and frequency of necessary packet transmissions while sending the positioning data to the tracking server.

Normally a mobile terminal with an onboard positioning system needs to send its positioning data always when the terminal has moved a certain distance or the tracking is made with fixed time intervals. Another way is to ask the positioning data from terminal on demand. Both ways are generating a large amount of data to be sent over the mobile network. The transmission of large amount of data is expensive and it generates a large load to the server and to the network. Typically, a car diving speed normally used in a city is sending several packets in a minute. For example in case of tracking all the taxis of a large city this generates remarkable large amount of data in a minute. Even with GPRS transmission, this win cost quite a lot and in case of SMS or dosed network radio modem the amount of data would generate costs or s limitations that would force the system to use very low tracking frequency and thus the tracking accuracy will be low.

The object of the invention is to minimize the network load of the mobile network used for sending the positioning information while providing also the specified and guaranteed accuracy that is needed for tracking. The accuracy can be adjusted according to the need or it can be a function of the state of the mobile station. The state of the mobile station is defined as the minimum information set that contains everything that can be known from current and future bias of the system given the measurement history.

The invention is based on idea that the mobile terminal calculates a prediction or estimate of its path of movement using the measurement history it has and it sends the parameters of the prediction to the server that is tracking the mobile terminal. Then the server can calculate the same estimated path with the same parameters. After sending the parameters, the mobile terminal is comparing the predicted path to the real path of movement and a triggering condition for the error of the prediction. The triggering condition may vary according to the state information of the mobile station. Because both terminal and the server have the same prediction of the path and the mobile terminal knows both the estimated and real position, the maximum error can be limited to a predetermined value known by both the mobile station and the tracking server.

The maximum error value may by different on the direction of movement and the direction perpendicular to the (predicted) movement. Also the time derivate may have own triggering condition. This means, that for example a quick turn generates immediate positioning message, but a slight curving generates message after a larger displacement from the predicted path. Maybe in the city, the velocity changes are not considered to be important to track. This would lead to a situation, that tracking could tell the street, but not necessarily the exact location on it. Usually this leads to positioning message, that is send after stopping for a while in the traffic lights. In this case, the estimate advantageously is predicting green lights and is not generating next message on starting, if the driving direction after crossing is the estimated and starting happens within error marginal. The maximum error can be also given by the operator of the mobile terminal or by the user of the tracking data. This happens for example when guiding the mobile station to the exact destination, and the accuracy of the tacking should be only a few meters. The filtering function that generates the estimate can be set so that the error estimate and therefore the triggering condition depend on the historical distribution of states. This helps to keep the amount of data sent small without losing the tracking accuracy more than necessary.

The parameters may include only one or more resent position or maybe also the time derivatives of the moving path, this means the terminal may tell also its speed, acceleration, curvature of its path. Also the distribution of for example speed changes can have an effect. The details of the mathematical background are described later with reference to well known theories. The difference value may have different tolerances in different directions, this means that for example a car is telling practically immediately about its abrupt turn, bit would wait a bit longer about telling its acceleration. In tracking way this would mean that the server would know at least turning in each crossing, even for a short time the positioning may indicate car going straight through a crossing even if it is not yet reached the crossing and the car may still turn. This maximum error could be presented to the operator of telemetric programme in graphical way, if needed. This would warn about the critical errors.

Next, the mathematical background of the known technology is described.

Following course books covers the mathematical background profoundly: Bar-Shalom, Y., Li. X.-R, and Kirubarajan, T. (2001): Estimation with Applications to Tracking and Navigation Theory Algorithms and Software. John Wiley & Sons, and Jazwinski, A. (1970): Stochastic Processes and Filtering Theory. New York.

When the mobile station reports its state (e.g. position and velocity), it may report not only the point estimate, but also the confidence or precision of the estimate. More abstractly, the mobile terminal may send for example Posterior State Distribution on current time. The suitable forms of report are at least sufficient statistics, such as mean and covariance, or an estimate plus some kind of Dilution of Precision (DOP) values. Other forms are Mixture Gaussian distributions, typically multiple mode filter and Monte Carlo filters. However, this posterior distribution can be presented with any kind of finite set of sufficient statistics parameters or equivalent, such as set of Monte Carlo samples.

The physical model for the dynamics of the module can be modelled using Markov Process model, which can be for example generic linear stochastic differential equation model. Well-known algorithms for estimation (filtering) in linear and almost linear models are Kalman Filter and extended Kalman Filter. They are explained in the mentioned book by Bar-Shalom et al.

Multiple mode model is one possible estimation model, it includes Mixture Distribution of Modes, (e.g. Mixture of Gaussian modes) Typically, jumping from mode to another is modelled as Markov Process or Markov Chain. A common algorithm is the Interacting Multiple Model, described also in Bar-Shalom et al.

Optimal prediction refers to the concept that given the posterior probability distribution of state and the stochastic model of dynamics, there is exactly one way to combine this information such the prediction error is minimized. This is called Optimal Prediction. In theory, this is done by solving the Fokker-Planck-Kolmogorov (FPK) Partial differential equation (explained in mentioned book by Jazwinski). The solution gives the entire predicted posterior distribution. However, in estimation theory, we are actually interested in mean estimate or sufficient statistics instead of the whole distribution, explicit usage of FPK is not necessary. For example, prediction with Linear Stochastic Differential Equations and Multiple Mode Models can be implemented by finite set of recursive matrix operations (see, Bar-Shalom et al., 2001).

The wanted properties of error criterion are:
If error criterion rises over certain threshold, then we need new measurement or updated state estimate. This information can be used for triggering state updates in given situations.
Estimates are formed such that error criterion is minimized, which in turn minimizes the state update frequency. This error criterion can be simplified (or modified) version of the trigger error criterion above. Error criterion can, for example, measure the prediction error and put some constants in accelerations or velocities. This criterion may also contain connections to any other that imply that something has occurred and we need to update the state. Therefore, we can program the error criterion to make updates in special events if we want to.

In following a simple usage of an estimate is described with reference to a figure. The example is simplest possible embodiment according to the invention, it takes in account only the speed vector and absolute position and the maximum error estimate is simply a constant radius of error circle.

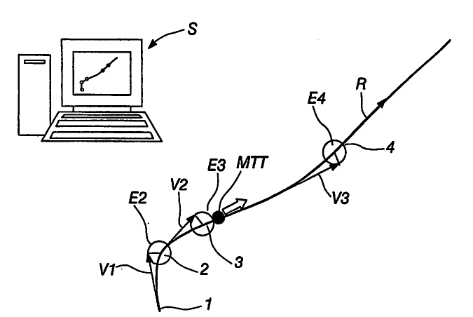

FIG. 1 shows the simple system with one mobile station.

In FIG. 1 the mobile station MTT is driving along the road R, in positions 1 to 4 the mobile station MTT sends its state information. In this example the information includes only the position and speed vector. The estimated movement after last report is calculated as a product of time since last report and the speed vector V1 to V3. In positions 2 to 4 the error circle, which is the maximum distance been the estimated location and the actual location has been exceeded. The maximum distance is the radius of the error circle E2 to E4. The server S receives the state information messages, and the user program can draw a map with the location of the mobile station MTT.

In more advanced embodiment, the error is not described as a circle, but it is a function of the historical measurement information of the position of the mobile station MTT. The measurement information includes typically some first order derivatives of the moving path and maybe also information of a longer time, in form of for example acceleration and turning distribution, or a classification of this distribution. The classification information may be also a state variable that tells the latest behavior of the mobile station MTT. For example the state variable may tell, that driving is typical rush-time city driving, or typical motorway driving with very little speed changes. This information may be used to change the error limits. The system can use accelerometer to measure the accelerations. Accelerometer is much faster to react turing, acceleration, breaking and all other measured variables. If all the degrees of freedom are measured, the measurement of acceleration can be used to help the GPS data. The degrees of freedom are X, Y and Z coordinates and also preferably all axles of notation. It is also possible to calculate position as integral of the acceleration to get the position for example inside a parking hall, when the GPS data is not valid. The positioning accuracy expectation is low after a long time of movement without GPS-data, but anyway better than nothing. At least the mobile station can always tell its direction of turning. Preferably the distance of movement is measured by counting the turns of the wheel, taking in account, that the result is not always valid, if the friction of the wheels is too low. The calibration of acceleration and distance measurements is made with the GPS data.

Naturally the turning signal and breaking light is preferably one part of the measured information. This makes it possible to guess the crossings and exits and also not to react on a small direction change during take over condition. In take over and in the highway entrances the left turning signal and acceleration happens nearly same time. This external information helps to generate more probable estimates, because it is possible to learn or to program probable behavior of the mobile station.

It is characteristic to the invention what is said in the independent patent claims and the dependent claims are presenting advantageous embodiments according to the invention. The invention can be modified within the scope of the claims.

1. A method to reduce amount data to be sent in a tracking system of a mobile station (MTT) having a positioning device to obtain positioning data, and the mobile station (MTT) and the server (S) perform the following steps:
the mobile station (MTT) sends its dynamic state parameters including at least the position and velocity, which are derived from the positioning measurements, to server (S), characterized in that
the mobile station (MTT) computes an error criterion based on said sent dynamic state and current dynamic state, which is derived from new positioning measurements, such that the error criterion is calculated based on at least sent and current velocities,
the mobile station (MTT) sends a set of new dynamic state parameters, when the said error criterion is over a predefined limit.

2. The method according to the claim 1, characterized in that the server (S) calculates predicted dynamic state, using the dynamic state parameters sent by (MTT) when the position information is needed.

3. The method according to the claim 1, characterized in that the mobile station (MTT) calculates predicted dynamic state from the said sent dynamic state parameters and uses this predicted dynamic state in the error criterion.

4. The method according to claim 1, characterized in that the mobile station (MTT) sends at least one position measurement, velocity and at least second order derivatives of the position.

5. The method according to claim 1, characterized in that the mobile station (MTT) is including with the dynamic state parameters information about proactive incidents, for example turning signal, or brake light.

6. The method according to claim 1, characterized in that the calculation of the error criterion takes into account the difference between the sent or predicted and current velocities.

7. The method according to claim 1, characterized in that the calculation of the error criterion takes into account angle between the sent or predicted and current velocities.

8. The method according to claim 1, characterized in that the calculation of the error criterion takes into account the at least second order time derivatives of position history.

9. The method according to claim 5, characterized in that the calculation of the error criterion takes into account the difference between predicted and current positions.

10. The method according to claim 1, characterized in that the message sent by the mobile station (MTT) includes the necessary information needed to recover the same data in the mobile station (MTT) and in the receiving server (S) after one or more messages being missing, and the recovery needs one or more, but limited amount of messages.

11. A mobile device (MTT) for use in a tracking system, comprising a positioning device to obtain positioning data and,
means to send data to a server (S), characterized in that the device (MTT) comprises
means to send its dynamic state parameters including at least the position and velocity, which are derived from the positioning measurements, to server (S),
means to compute an error criterion based on said sent dynamic state and current dynamic state, which is derived from new positioning measurements, such that the error criterion is calculated based on at least sent and current velocities, and
means to send a set of new dynamic state parameters, when the said error criterion is over a predefined limit.

12. A arrangement to reduce amount data to be sent in a tracking system of a mobile station (MTT) having a positioning device to obtain positioning data, and the mobile station (MTT) and the server (S) adapted to perform the following steps:
the mobile station (MTT) sends its dynamic state parameters including at least the position and velocity, which are derived from the positioning measurements, to server (S), characterized in that
the mobile station (MTT) computes an error criterion based on said sent dynamic state and current dynamic state, which is derived from new positioning measurements, such that the error criterion is calculated based on at least sent and current velocities,
the mobile station (MTT) sends a set of new dynamic state parameters, when the said error criterion is over a predefined limit.
